(19) United States
(12) Patent Application Publication
(10) Pub. No.: US 2014/0337024 A1
(43) Pub. Date: Nov. 13, 2014

(54) METHOD AND SYSTEM FOR SPEECH COMMAND DETECTION, AND INFORMATION PROCESSING SYSTEM

(71) Applicant: CANON KABUSHIKI KAISHA, Tokyo (JP)

(72) Inventors: Xiang Zuo, Beijing (CN); Weixiang Hu, Beijing (CN); Hefei Liu, Beijing (CN)

(73) Assignee: CANON KABUSHIKI KAISHA, Tokyo (JP)

(21) Appl. No.: 14/274,500

(22) Filed: May 9, 2014

(30) Foreign Application Priority Data
May 13, 2013 (CN) 201310173959.0

(51) Int. Cl. G10L 15/02

(52) U.S. Cl. CPC G10L 15/02
USPC 704/239

(57) ABSTRACT

A method for speech command detection comprises extracting speech features from a speech signal inputted into a system, converting the speech features into a word sequence, obtaining time durations of speech segments corresponding to the respective non-command words and an acoustic score of each of the command word candidates, calculating rhythm features of the speech signal based on the time durations, and recognizing a speech corresponding to the at least one command word candidates as a speech command directed to the system or a speech not directed to the system based on the acoustic score and the rhythm features. The word sequence comprises at least two successive non-command words and at least one command word candidate. The rhythm features describe a similarity of time durations of speech segments corresponding to the respective non-command words, and/or a similarity of energy variations of the speech segments corresponding to the respective non-command words.

### BACKGROUND

1. Field

The present subject matter relates to a method and system for speech detection and processing. More particularly, the present subject matter relates to a method and system for speech command detection.

2. Description of Related Art

The Speech technique is a kind of intelligent information technique developed with the evolution of digital signal processing techniques in the 1960s. Due to its significant contribution to product automation, the speech technique has become one of the most popular techniques nowadays.

One of the important applications of the speech technique is to be adopted for system operation. Particularly, for the users such as a kid or the aged or visually impaired, the speech is an effective user interface (UI) for system operation.

For a speech controlled system, an important issue is to distinguish speech commands that users speak to the system from other speeches (such as, background noises from a television or user chatting speeches). For example, a user's speech directed to another human listener should not be recognized as a speech command directed to the system.

This problem can be resolved simply by using a button for controlling speech inputting. For example, we can develop a system provided with a button, which recognizes a speech as a speech command directed to the system only while a user is pressing the button. However, this method raises a problem that it needs manually operations, and thus is unsuitable for hands-busy tasks.

On the other hand, some previous methods adopt human physical behaviours to estimate the target of the user's speech. For example, in “Evaluating Crossmodal Awareness of Daily-partner Robot to User's Behaviors with Gaze and Utterance Detection” written by T. Yonezawa, H. Yamazoe, A. Utusmi and S. Abe, published in “Proceedings of the ACM International Workshop on Context-Awareness for Self-Managing Systems,” 2009, pp. 1-8 and “Conversation root with the function of gaze recognition” written by S. Fujie, T. Yamahata, and T. Kobayashi, published in “Proceedings of the IEEE-RAS International Conference on Humanoid Robots,” 2006, pp. 364-369, a following method has been described: the direction of a user's gaze or body orientation is detected, and when it is detected that a user's gaze or body orientation is directed to the system, the speech is recognized as a speech command to the system. However, to implement the above method, in addition to a microphone, the system also requires other sensors (e.g. a camera) for recognizing the user's gaze or body orientation, thus increasing the manufacturing cost of the system. Besides, even in the case of a user facing the system, it cannot ensure that the received speech is just the speech command directed to the system, thus the reliability of the system is low.

To solve the above described problems, it is desired to detect speech commands only by speech, without using a button or any kinds of physical body behaviours.

Apple Inc. has developed a Mac OS speech recognition system, with which the users can control computers through speaking speech commands. In the system, a speech command may be a single command word or a sequence of multiple command words. FIG. 1 shows the interface of the Mac OS speech recognition system. With regard to that system, there are two modes for the users to carry out the speech command recognition.

In the first mode, users have to speak a predefined preceding word before each speech command. For example, the preceding word predefined by a user is “Hi Canon”, and a speech command the user wants the system to receive is “DELETE”. When the user speaks “Hi Canon, DELETE”, the system may determine a speech command “DELETE” directed to the system.

FIG. 1B is a flowchart of a method for speech command detection according to the first mode of the Mac OS speech recognition system in the prior art. At first, the features of input speech are extracted at step S11. Then, at step S12, according to a stored acoustic model, a lexicon and a grammar, the speech recognition is carried out based on the extracted speech features to derive a word sequence. At step S13, the word sequence derived at the speech recognition step is classified, that is, if the word sequence comprises a preceding word and a command word candidate, the speech corresponding to the command word candidate is recognized as the speech command directed to the system; otherwise, the input speech is recognized as the speech which is not directed to the system.

FIG. 2A shows a grammar used in the first mode of the Mac OS speech recognition system in the prior art, in which “C” represents a command word candidate, “GBG” represents a garbage word, “P” represents a preceding word, and “start” and “end” represent silence portions before and after the interested speech respectively. If the speech recognition is performed by using such a grammar and the recognized word sequence comprises a preceding word and a command word candidate, the command word candidate will be determined as the speech command directed to the system.

In this mode, the system performance completely depends on the accuracy of the speech recognition engine used by the system. The system becomes unreliable under some situations where the accuracy of speech recognition is low (e.g. low SNR conditions).

In the second mode, users can speak speech commands at any time without speaking a preceding word. In this manner, speech command detection can be made by using the keyword spotting techniques in the prior art.

FIG. 1C is a flowchart of a method for speech command detection according to the second mode of the Mac OS speech recognition system in the prior art. At first, the features of input speech are extracted at step S21. Then, at step S22, according to a stored acoustic model, a lexicon and a grammar, the speech recognition is performed based on the extracted speech features to derive a word sequence. At step S23, the word sequence derived at the speech recognition step is classified, that is, if a command word candidate is recognized from the word sequence derived at step S22, the input speech is recognized as containing the speech command directed to the system; otherwise, the input speech is recognized as the speech not directed to the system.

FIG. 2B shows a grammar used in the second mode of the Mac OS speech recognition system in the prior art, in which “C” represents a command word candidate, “GBG” represents a garbage word, and “start” and “end” represent silence portions before and after the interested speech respectively. Through the speech recognition with this grammar, the command word (C) will be recognized from the input speech, and it may be determined whether the input speech contains speech commands directed to the system.

Also, for the second mode, because the system performance completely depends on the performance of the speech recognition engine used in the system, the system performance will be deteriorated significantly under some situations (e.g. low SNR conditions) when the performance of speech recognition becomes low.

In a Chinese patent application No. CN200810021973.8, another speech command detection method is disclosed, in which speech command detection is performed based on both of a preceding word before a speech command candidate and a succeeding word after the speech command candidate. Similar to the Mac OS speech recognition system from the Apple Inc., the method may become unreliable in low SNR conditions.

Therefore, it is desired to provide a new technique to address the problems in the prior art.

### SUMMARY

An object of the present subject matter is to improve the accuracy for detecting the speech command directed to the system, particularly to improve the accuracy of speech command detection in low SNR conditions.

To solve the above problems, a method for speech command detection is provided in the present subject matter, which is based on not only automatic speech recognition, but also rhythm features of input speech. The method receives the speech command candidates spoken together with preceding speech segments or/and succeeding speech segments spoken with a certain rhythm, and then detects the speech commands in the input speech. The preceding speech segments or/and succeeding speech segments may be any voices except the speech commands. For example, the voices may be the voices corresponding to digits. The rhythm could be determined by a user beforehand. The rhythm features include at least one of: a feature describing the similarity of time durations of the preceding/succeeding speech segments, and a feature describing the similarity of energy variations of the preceding/succeeding speech segments.

According to one aspect of the present subject matter, a method for speech command detection is provided, comprising: a feature extraction step, for extracting speech features from a speech signal inputted into a system; a speech recognition step, for converting the speech features into a word sequence, wherein the word sequence comprises at least two successive non-command words and at least one command word candidates, and obtaining time durations of speech segments corresponding to the respective non-command words and an acoustic score of each of the command word candidates; a rhythm analysis step, for calculating rhythm features of the speech signal based on the time durations; and a classification step, for recognizing a speech corresponding to the at least one command word candidates as a speech command directed to the system or a speech not directed to the system based on the acoustic score and the rhythm features, wherein the rhythm features describe a similarity of time durations of speech segments corresponding to the respective non-command words, and/or a similarity of energy variations of the speech segments corresponding to the respective non-command words.

According to another aspect of the present subject matter, a device for speech command detection is provided comprising: a feature extraction unit, for extracting speech features from a speech signal inputted into an information processing system; a speech recognition unit, for converting the speech features into a word sequence, wherein the word sequence comprises at least two successive non-command words and at least one command word candidates, and obtaining time durations of speech segments corresponding to the respective non-command words and an acoustic score of each of the command word candidates; a rhythm analysis unit, for calculating rhythm features of the speech signal based on the time durations; and a classification unit, for recognizing a speech corresponding to the at least one command word candidates as a speech command directed to the information processing system or a speech not directed to the information processing system based on the acoustic score and the rhythm features, wherein the rhythm features describe a similarity of time durations of speech segments corresponding to the respective non-command words, and/or a similarity of energy variations of the speech segments corresponding to the respective non-command words.

According to still another aspect of the present subject matter, an information processing system is provided, comprising the device for speech command detection described above. The information processing system may be selected from a group comprising: a digital camera, a digital video recorder, a mobile phone, a computer, a television, a security control system, an e-book, or a game player.

An advantage of the present subject matter is to provide a method and system capable of recognizing accurately the speech command directed to the system accurately only by the speech.

Another advantage of the present subject matter is in that, because the acoustic score of the speech command candidate and the rhythm features of the input speech signal are jointly used, the subject matter is more robust under noisy conditions than the prior arts.

Further features of the present subject matter and advantages thereof will become apparent from the following detailed description of exemplary embodiments of the present subject matter that are given with reference to the attached drawings.

### BRIEF DESCRIPTION OF THE DRAWINGS

The accompanying drawings, which constitute a part of the specification, illustrate embodiments of the subject matter and, together with the description, serve to explain the principles of the subject matter.

With reference to the accompanying drawings, a clear understanding of the present subject matter may be obtained from the following detailed description, in which:

FIG. 1A is a diagram showing the interface of the Mac OS speech recognition system in the prior art, and FIG. 1B and FIG. 1C show flowcharts of methods used in the two modes of the Mac OS speech recognition system in the prior art, respectively.

FIG. 2A and FIG. 2B show grammar structures used in the two modes of the Mac OS speech recognition system in the prior art respectively.

FIG. 3 is a schematic block diagram of the hardware configuration of a computer system 1000 which can implement the embodiment of the present subject matter.

FIG. 4 is a flowchart showing a method for speech command detection according to an embodiment of the present subject matter.

FIG. 5 shows a grammar structure used in speech command detection according to an embodiment of the present subject matter.

FIG. 6 shows an example of word sequence recognized by using a speech recognition technique.

FIG. 7 shows waveforms of input speech, energy variations of the various frames, and the autocorrelation of energy variations of speech portions before a speech command candidate.

FIG. 8 shows the working principle of the Support Vector Machine (SVM) method;

FIG. 9 shows a functional block diagram of a device 200 for speech command detection according to an embodiment of the present subject matter.

FIG. 10 shows F-measures obtained through testing according to the embodiment of the present subject matter and the two modes in the Mac OS speech recognition system.

### DETAILED DESCRIPTION

Various exemplary embodiments of the present subject matter will now be described in detail with reference to the drawings. It should be noted that the relative arrangement of the components and steps, the numerical expressions, and numerical values set forth in these embodiments do not limit the scope of the present subject matter unless it is specifically stated otherwise.

The following description of at least one exemplary embodiment is merely illustrative in nature and is in no way intended to limit the subject matter, its application, or uses.

Techniques, methods and apparatus as known by one of ordinary skill in the relevant art may not be discussed in detail but are intended to be part of the specification where appropriate.

In all of the examples illustrated and discussed herein, any specific values should be interpreted to be illustrative only and non-limiting. Thus, other examples of the exemplary embodiments could have different values.

Notice that similar reference numerals and letters refer to similar items in the following figures, and thus once an item is defined in one figure, it is possible that it need not be further discussed for following figures.

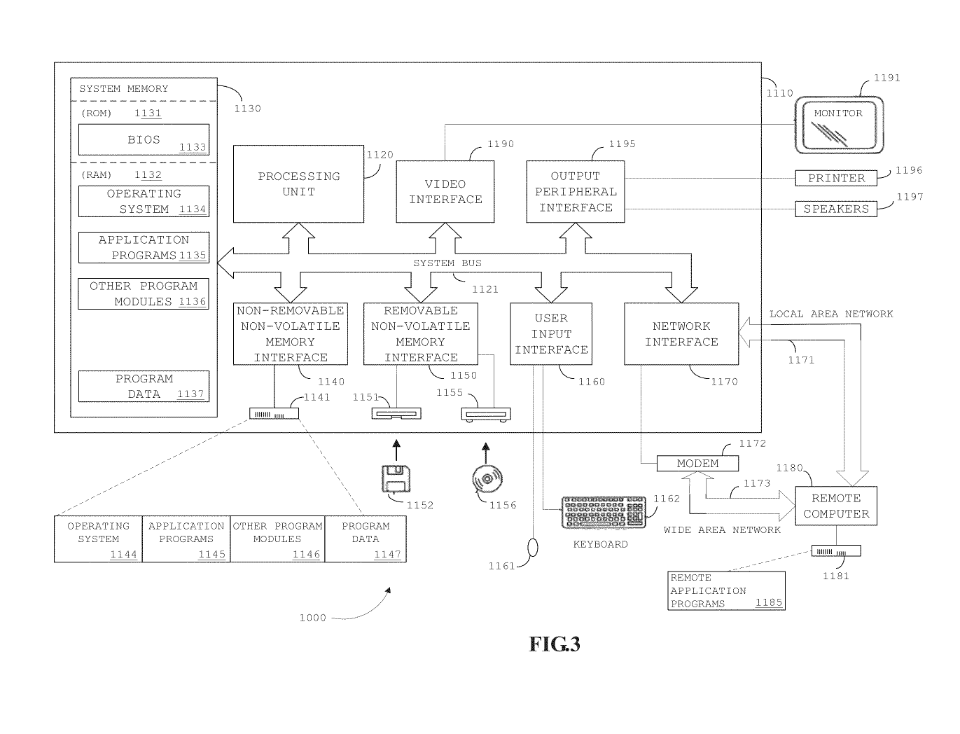

FIG. 3 is a schematic block diagram showing a hardware configuration of a computer system 1000 which can implement the embodiments of the present subject matter.

As shown in FIG. 3, the computer system comprises a computer 1110. The computer 1110 comprises a processing unit 1120, a system memory 1130, a non-removable non-volatile memory interface 1140, a removable non-volatile memory interface 1150, a user input interface 1160, a network interface 1170, a video interface 1190 and an output peripheral interface 1195, which are connected via a system bus 1121.

The system memory 1130 comprises a ROM (read-only memory) 1131 and a RAM (random access memory) 1132. A BIOS (basic input output system) 1133 resides in the ROM 1131. An operating system 1134, application programs 1135, other program modules 1136 and some program data 1137 reside in the RAM 1132.

A non-removable non-volatile memory 1141, such as a hard disk, is connected to the non-removable non-volatile memory interface 1140. The non-removable non-volatile memory 1141 can store an operating system 1144, application programs 1145, other program modules 1146 and some program data 1147, for example.

Removable non-volatile memories, such as a floppy drive 1151 and a CD-ROM drive 1155, are connected to the removable non-volatile memory interface 1150. For example, a floppy disk 1152 can be inserted into the floppy drive 1151, and a CD (compact disk) 1156 can be inserted into the CD-ROM drive 1155.

Input devices, such a mouse 1161 and a keyboard 1162, are connected to the user input interface 1160.

The computer 1110 can be connected to a remote computer 1180 by the network interface 1170. For example, the network interface 1170 can be connected to the remote computer 1180 via a local area network 1171. Alternatively, the network interface 1170 can be connected to a modem (modulator-demodulator) 1172, and the modem 1172 is connected to the remote computer 1180 via a wide area network 1173.

The remote computer 1180 may comprise a memory 1181, such as a hard disk, which stores remote application programs 1185.

The video interface 1190 is connected to a monitor 1191.

The output peripheral interface 1195 is connected to a printer 1196 and speakers 1197.

The computer system shown in FIG. 3 is merely illustrative and is in no way intended to limit the subject matter, its application, or uses.

The computer system shown in FIG. 3 may be implemented to any of the embodiments, either as a stand-alone computer, or as a processing system in an apparatus, possibly with one or more unnecessary components removed or with one or more additional components added.

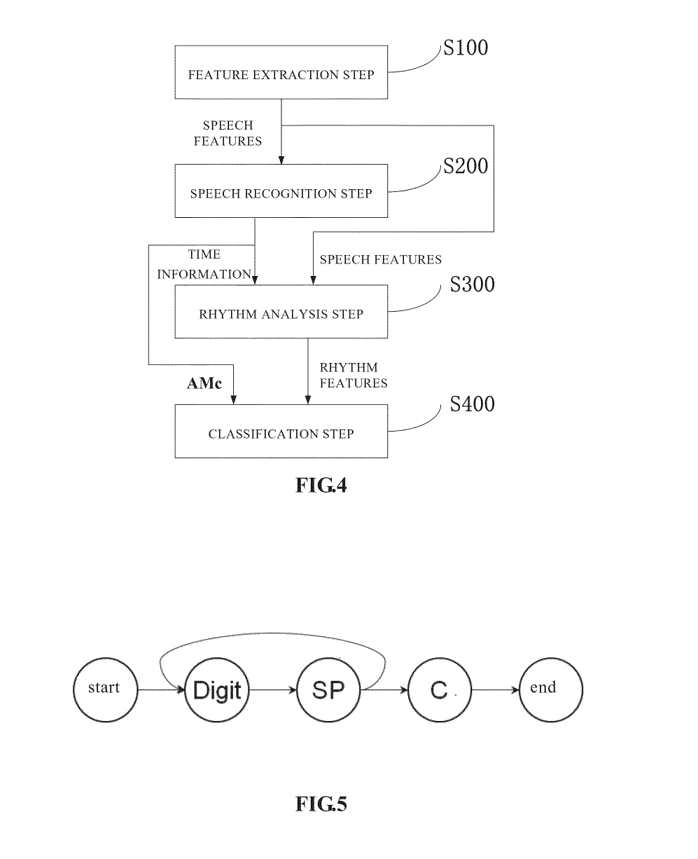

FIG. 4 shows a flowchart of a method according to an embodiment of the present subject matter. As shown in FIG. 4, at step S100, a digital speech signal d is received, and the speech features of various frames are extracted from the digital speech signal d. Alternatively, in one embodiment, the speech features are 25-dimensional feature vectors, including a power of the speech, a mel-scale cepstrum of the speech, and a delta cepstrum of the speech (which is a difference in mel-cepstrum between frames). The speech features could be extracted by using techniques known in the art, for example, the voice activity detection (VAD) technique. For the purpose of concision, the description thereof will be omitted herein.

At step S200, through using a speech recognition method known in the art, based on the speech features extracted at step S100, speech recognition is performed on the digital speech signal d.

For example, the speech features extracted at step S100 are decoded by applying a search algorithm (such as, the Viterbi algorithm) to obtain a recognition result. During the process of decoding an acoustic model and a language model need to be used. The acoustic model used at step S200 may be stored in an external acoustic model storage of the system. In one embodiment, the acoustic model is context independent HMMs, with Gaussian mixture distributions in each state. The language model comprises a lexicon and a grammar used in the speech recognition. The lexicon used in the speech recognition is stored in an external lexicon storage, and the grammar used in the speech recognition is stored in an external grammar storage.

According to the embodiment of the present subject matter, the input speech may comprise, for example, speeches corresponding to non-command words, short pauses, speeches corresponding to command word candidates, and silence portions near the start and the end of this input speech. FIG. 5 shows a grammar structure used in the speech command detection according to an embodiment of the present subject matter. As shown in FIG. 5, “Digit” represents a digital word, which is not a command; “SP” represents a short pause between non-command words or between a non-command word and a command word candidate; “C” represents a command word candidate; and “Start” and “End” respectively represent silence portions near the start and the end of the speech segment.

According to an embodiment of the present subject matter, the input speech comprises speech segments corresponding to at least two successive non-command words and a speech segment corresponding to at least one command word candidates, wherein the speech segment corresponding to the at least one command word candidates locates after the speech segments corresponding to the at least two successive non-command words. In a further embodiment, the non-command words may be digits. The so-called “successive non-command words” means that there is only a short pause, but not any command word candidate, between those non-command words. Nevertheless, as appreciated by those skilled in the art, the non-command words may not be digits. Those skilled in the art may understand that the speech segments corresponding to the at least two successive non-command words may be any voices except those corresponding to the at least one command word candidates.

According to another embodiment of the present subject matter, the speech segment corresponding to the at least one command word candidates precedes the speech segments corresponding to the at least two successive non-command words.

According to still another embodiment of the present subject matter, the speech segments corresponding to at least two successive non-command words are provided both before and after the speech segment corresponding to the at least one command word candidates.

Continuing with FIG. 5, according to an embodiment of the present subject matter, using the grammar described above, the speech features extracted from the input speech d may be converted into a word sequence by using a speech recognition technique known in the art, wherein the word sequence comprises several pairs (Pᵢ) of a non-command word (for example, a digit) and a short pause, and at least one command word candidates (c), wherein i represents the index of the pauses, the pair number may be a natural number larger than or equal to 2. In an embodiment, the word sequence may be “‘ONE’, ‘TWO’, ‘DELETE’”, wherein i=2. In another embodiment, the word sequence may be “‘ONE’, ‘TWO’, ‘THREE’, ‘DELETE’”, wherein i=3.

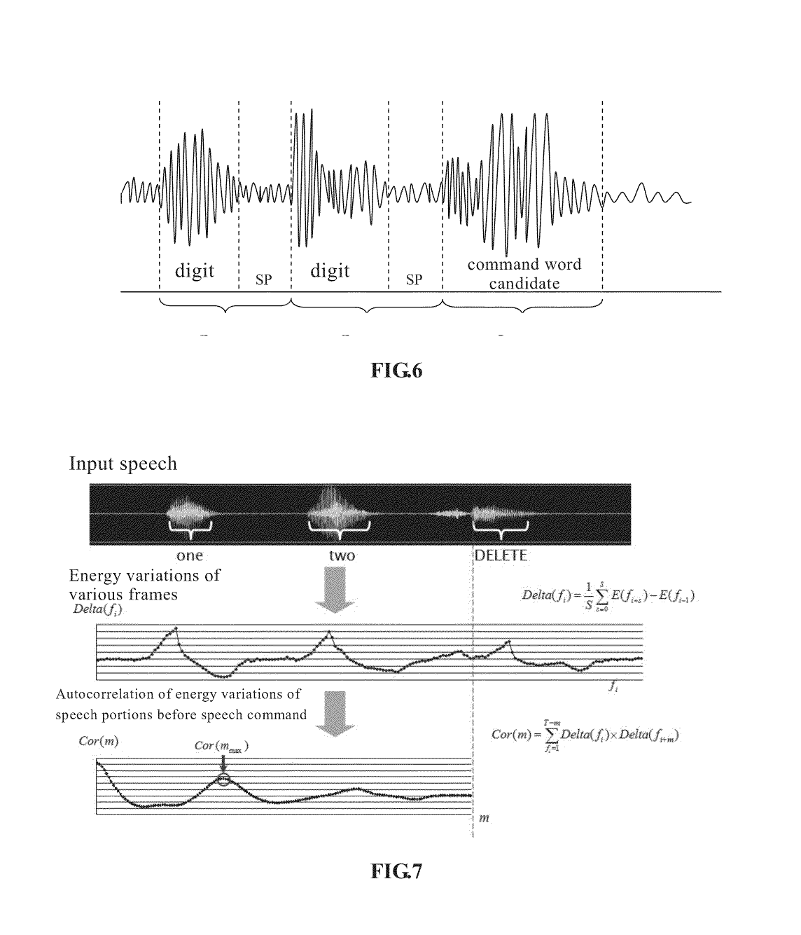

Each pair (Pᵢ) of a non-command word (digit word) and a short pause is indicated as a speech segment corresponding to a non-command word. A time duration tᵢ of each pair Pᵢ (i.e., a speech segment corresponding to a non-command word) and an acoustic score AMc of each command word candidates (c) may be obtained at the speech recognition step. Those skilled in the art may understand that the acoustic score AMc of a command word candidate (c) is a parameter representing the probability of the command word candidate being an actual command word. The acoustic score AMc of a command word candidate (c) may be calculated according to the methods known in the art. The acoustic score may be obtained through, for example, using the Viterbi algorithm. FIG. 6 shows an example of a word sequence obtained using a speech recognition technique. It can be seen that the speech comprises speech segments corresponding to two successive non-command words and a speech segment corresponding to a command word candidate.

Returning to FIG. 4, a rhythm analysis is performed at step S300. That is, based on the time durations tᵢ obtained at step S200 and the acoustic features extracted at step S100, rhythm features of the digital speech signal d are calculated. The rhythm features may describe the similarity of time durations of speech segments corresponding to the respective non-command words, and/or the similarity of energy variations of speech segments corresponding to the respective non-command words.

The rhythm features may comprise at least one of: an average length of time durations of speech segments corresponding to the at least two successive non-command words (i.e., at least two pairs (Pᵢ) of a non-command word and a short pause); a variance of time durations of speech segments corresponding to the at least two successive non-command words; a normalized maximum value of the autocorrelation of energy variations of speech segments corresponding to the at least two successive non-command words; a base frequency (F0) of speech segments corresponding to the at least two successive non-command words; and energies of speech segments corresponding to the at least two successive non-command words.

In one embodiment, the following three metrics are selected as rhythm features: an average length (r₁) of time durations of speech segments corresponding to the at least two successive non-command words; a variance (r₂) of time durations of speech segments corresponding to the at least two successive non-command words; a normalized maximum value (r₃) of the autocorrelation of energy variations of speech segments corresponding to the at least two successive non-command words.

The average length r₁ of time durations of speech segments corresponding to the at least two successive non-command words may be calculated as follows:

$${r}_{1} = \frac{1}{N} {\sum }_{i = 1}^{N} {t}_{i} \qquad ( 1 )$$

wherein N is the total number of speech segments corresponding to non-command words; and tᵢ is the time duration of the speech segment corresponding to the i^{th} non-command word.

The variance r₂ of time durations of speech segments corresponding to the at least two successive non-command words may be calculated as follows:

$${r}_{2} = \{ \begin{matrix}\frac{1}{N} {\sum }_{i = 1}^{N} {( {t}_{i} - {r}_{1} )}^{2} & i > 2 \\ \vert {t}_{1} - {t}_{2} \vert & i \leq 2\end{matrix} \qquad ( 2 )$$

wherein N is the total number of speech segments corresponding to non-command words; and tᵢ is the time duration of the speech segment corresponding to the i^{th} non-command word.

The third feature, i.e., the normalized maximum value r₃ of the autocorrelation of energy variations of speech segments corresponding to the at least two successive non-command words may be calculated as follows:

$${r}_{3} = \frac{{Cor ( m )}_{max}}{Cor ( 0 )} \qquad ( 3 )$$

wherein Cor(m)ₘₐₓ represents the maximum value of the autocorrelation of energy variations of the input speech in the case where m=0, and Cor (0) represents the autocorrelation of energy variations of the input speech in the case where m=0.

The autocorrelation Cor (m) of energy variations of the input speech may be calculated as follows:

$$Cor ( m ) = {\sum }_{{f}_{i} = 1}^{T - m} Delta ( {f}_{i} ) \times Delta ( {f}_{i + m} ) \qquad ( 4 )$$

wherein m represents the size of a sliding window when the autocorrelation of energy variations of the input speech is calculated, and fᵢ represents the i^{th} frame of the input speech. According to the embodiment of the present subject matter,

T=Σtᵢ (5)

because only the autocorrelation of speech segments corresponding to non-command words is calculated.

Delta (fᵢ) represents the energy variation at the fᵢ frame in the input speech, which may be calculated as follows:

$$Delta ( {f}_{i} ) = \frac{1}{S} {\sum }_{s = 0}^{S} E ( {f}_{i + s} ) - E ( {f}_{i - 1} ) \qquad ( 6 )$$

E (fi) represents the sum of sub-band energies of the i^{th} frame, which may be calculated according to methods known in the art. S represents a smooth factor, and the larger S is, the smoother the curve of Delta (fᵢ) is. S can be set by those skilled in the art based on experience, for example, S may be set to 10. FIG. 7 shows waveforms of an input speech, the energy variation of each frame, and the autocorrelation of energy variations of speech segments before a speech command candidate.

Besides, those skilled in the art may understand that other features may be selected as rhythm features, so long as the features may be used to describe the similarity of time durations of speech segments corresponding to the respective non-command words, or the similarity of energy variations of speech segments corresponding to the respective non-command words.

Returning to FIG. 4, at step S400, based on the acoustic score Amc obtained at speech recognition step S200 and the rhythm features obtained at the rhythm analysis step S300, the speech corresponding to the at least one command word candidates is recognized as a speech command directed to the system or a speech not directed to the system. In an embodiment, a classification step is performed based on the acoustic score obtained at step S200 and the three rhythm features (r₁, r₂, r₃) obtained at step S300. The classification step S400 may be implemented through the methods known in the art, for example, the Support Vector Machine (SVM) method that is well known in the art.

FIG. 8 shows the essential working principle of the Support Vector Machine (SVM) method. With respect to two sets of data (for example, circles and squares), we want to divide them with a hyperplane. There are many hyperplanes satisfying this requirement, for example, L1, L2 and L3. However, we want to find out a best hyperplane for the classification, which results in the largest spacing between the two sets of data. The best hyperplane is also called as the maximum-spacing hyperplane. In the example of FIG. 8, L2 is the maximum-spacing hyperplane. The input data are classified by this hyperplane.

In an embodiment, the rhythm features r1, r2, r3 and the acoustic score are the input data. Through SVM, the speech corresponding to at least one command word candidates may be recognized as a speech command directed to the system or a speech not directed to the system.

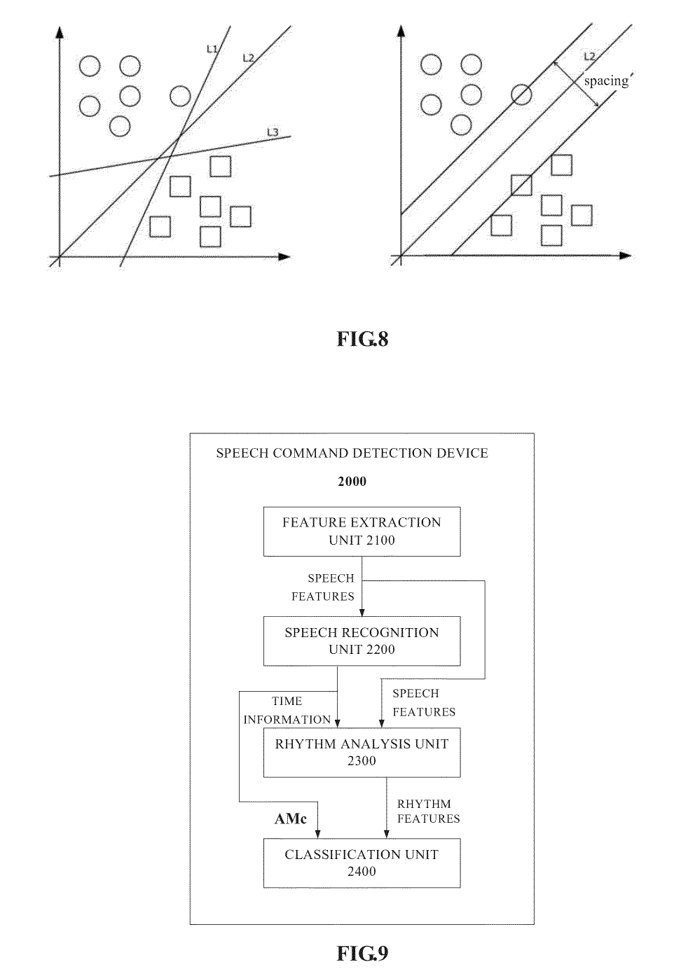

FIG. 9 is a functional block diagram of a device 2000 for speech command detection according to an embodiment of the present subject matter. The functional modules of the device 2000 for speech command detection may be realized in hardware, software, or a combination thereof, by which the principle of the present subject matter is implemented. Those skilled in the art may understand that functional modules depicted in FIG. 9 may be combined or divided into sub-modules to implement the above principle of the present subject matter. Therefore, this description may support any possible combination or division or further definition of those functional modules described herein.

As shown in FIG. 9, the device 2000 for speech command detection comprises: a feature extraction unit 2100, a speech recognition unit 2200, a rhythm analysis unit 2300, and a classification unit 2400. The feature extraction unit 2100 is configured to extract speech features from a speech signal inputted into an information processing system. The speech recognition unit 2200 is configured to convert the speech features into a word sequence, wherein the word sequence comprises at least two successive non-command words and at least one command word candidates, and to obtain time durations of speech segments corresponding to the respective non-command words and an acoustic score of each command word candidates. The rhythm analysis unit 2300 is configured to calculate rhythm features of the speech signal based on the time durations. The classification unit 2400 is configured to recognize the speech corresponding to the at least one command word candidates as a speech command directed to the information processing system or a speech not directed to the information processing system based on the acoustic score and the rhythm features. The rhythm features describe the similarity of time durations of speech segments corresponding to the respective non-command words, and/or the similarity of energy variations of speech segments corresponding to the respective non-command words.

In an embodiment, the speech corresponding to at least one command word candidates is located before speech segments corresponding to at least two successive non-command words or after speech segments corresponding to the at least two successive non-command words.

In an embodiment, the speech segments corresponding to at least two successive non-command words are provided both before and after the speech corresponding to the at least one command word candidates respectively.

In an embodiment, the speech segments corresponding to at least two successive non-command words may be any voices except those corresponding to the at least one command word candidates.

In an embodiment, the rhythm features comprise at least one of: an average length of time durations of speech segments corresponding to the at least two successive non-command words; a variance of time durations of speech segments corresponding to the at least two successive non-command words; a normalized maximum value of the autocorrelation of energy variations of speech segments corresponding to the at least two successive non-command words; a base frequency (F0) of speech segments corresponding to the at least two successive non-command words; and energies of speech segments corresponding to the at least two successive non-command words.

Furthermore, the device 2000 for speech command detection shown in FIG. 9 may be incorporated into any information processing system. The information processing system may comprise: a digital camera, a digital video recorder, a mobile phone, a computer, a television, a security control system, an e-book, or a game player, etc. Other components of the information processing system and connections between components of the information processing system and the device 2000 for speech command detection are well known by those skilled in the art, which will not be described in detail herein.
Performance test on the method and system for speech command detection according to the present subject matter

Performance testing of the method and system for speech command detection according to the present subject matter under different noisy conditions will be described below. The speech samples used for test are collected through the following steps. First, four data sets are prepared in text files, including 400 utterances labelled as either “system directed (SD)” or “not system directed (ND)”. The detail of the data sets is given in Table 1, in which the command words are indicated by underlines.

TABLE 1
speech sample data sets

| | # | Label | Description | Example |
|---|---|---|---|---|
| A | 100 | SD | Rhythm based speech commands | One, two, stop |
| B | 100 | ND | Chatting with speech commands | Let's get to start |
| C | 100 | ND | Chatting without speech | I cannot reserve a |
| | | | commands | meeting room |
| D | 100 | SD | A preceding word followed by | Hi Canon, delete |
| | | | speech commands | |

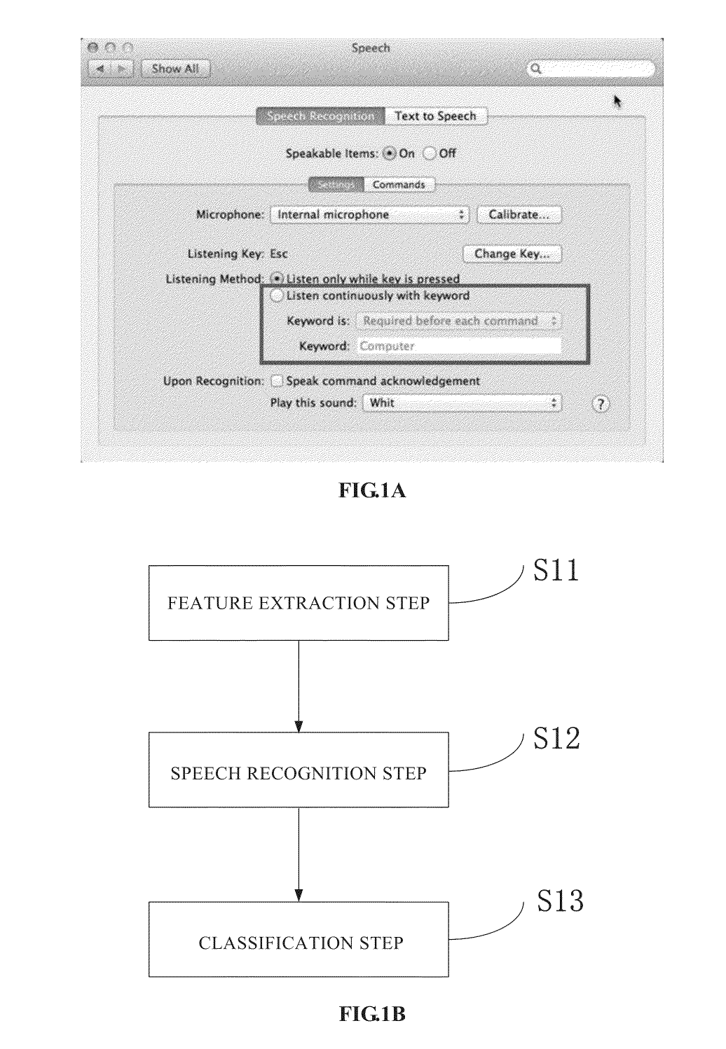

Second, the speech samples are recorded from four speakers. The speakers are told to read out the utterances in data set A with a certain rhythm, and to read out the utterances in data sets B, C and D as natural as they can. Data sets A, B and C are used for evaluating the method and system according to the present subject matter, and data set D is directed to the comparison example. In this test, the two modes of the Mac OS speech recognition system (as shown in FIG. 1(A)) in the prior art are used as the comparison examples with respect to the present subject matter. Leave-one-speaker-out cross validation is used for evaluating the embodiment of the present subject matter. That is, the speech samples collected from a speaker are used for testing, and the speech samples collected from the rest three speakers are used for training, and repeated four times.

F-measure is used as an evaluation metric, which is defined as

$$F - measure = \frac{2 \times Recall \times Precision}{Recall + Precision} ,$$

where Recall represents a recall rate, and Precision represents a precision, which are defined respectively as

$$Recall = \frac{{N}_{correct}}{{N}_{total}} , \\ and$$

$$Precision = \frac{{N}_{correct}}{{N}_{detected}} ,$$

where N_{correct} denotes the number of the commands directed to the system which are correctly detected, Nₜₒₜₐₗ denotes the total number of the existing commands directed to the system, and N_{detected} denotes the total number of speech that are detected as the commands directed to the system.

As mentioned above, the flowchart of the first mode in the Mac OS speech recognition system in the prior art is shown in FIG. 1B. The input speech will be determined as a speech command directed to the system, if both a preceding word and a command word candidate are recognized through the speech recognition step S12 in FIG. 1B. The flowchart of the second mode in the Mac OS speech recognition system in the prior art is shown in FIG. 1C. The speech will be determined as containing a speech command directed to the system if a keyword of a speech command is recognized through the speech recognition step S22 in FIG. 1C.

The embodiment of the present subject matter and the first and second modes of the Mac OS speech recognition system in the prior art share the same feature extraction step and the same speech recognition step. Moreover, the embodiment of the present subject matter and the first and second modes of the Mac OS speech recognition system in the prior art also share the same acoustic models and the same lexicon. However, the grammars and the classification steps used by the embodiment of the present subject matter and the first and second modes of the Mac OS speech recognition system in the prior art are different.

The lexicon used for the embodiment of the present subject matter and the first and second modes of the Mac OS speech recognition system in the prior art includes ten speech commands (start, play, forward, backward, pause, stop, power-on, delete, movie and photo), ten digits (from one to ten), a garbage word, a preceding word (Hi Canon), a silence segment and a short pause.

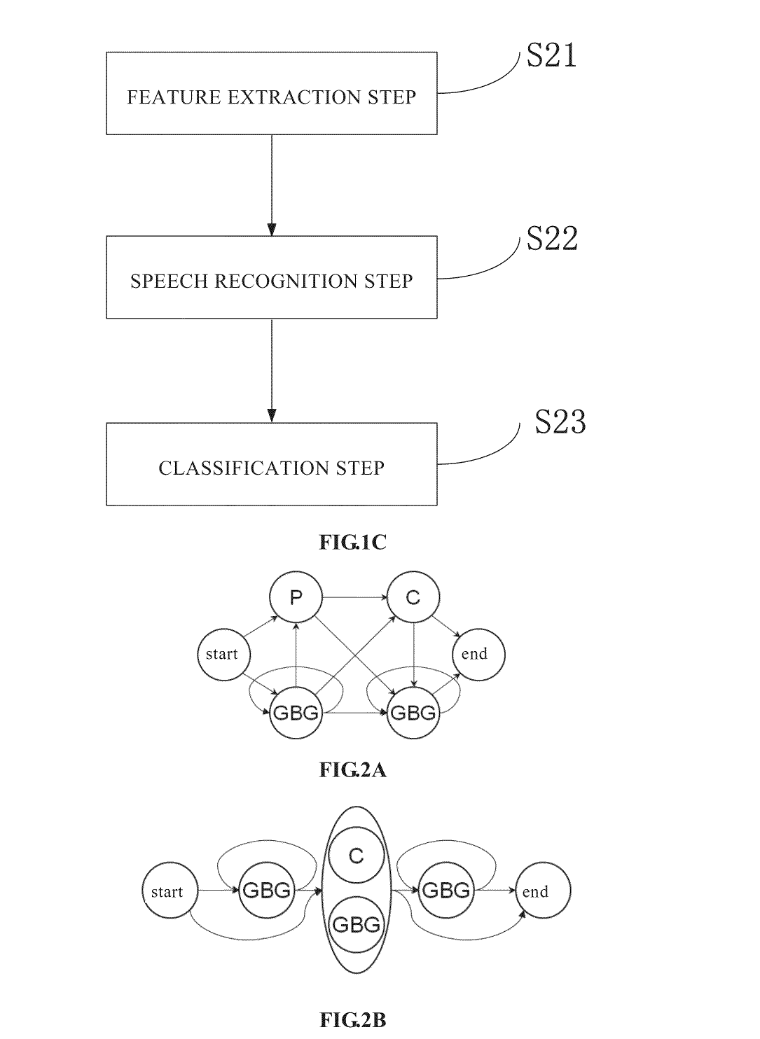

As mentioned above, the grammar structures used by the two modes in the Mac OS speech recognition system in the prior art are shown in FIG. 2A and FIG. 2B respectively. The grammar structure of the embodiment according to the present subject matter is shown in FIG. 5.

Data sets B, C and D are used for evaluating the first mode of the Mac OS speech recognition system, and data sets A, B and C are used for evaluating the second mode of the Mac OS speech recognition system. Different from the evaluation of the embodiment of the present subject matter, for the first and second modes of the Mac OS speech recognition system, all of the speech samples in the data sets are used for testing without the cross validation.

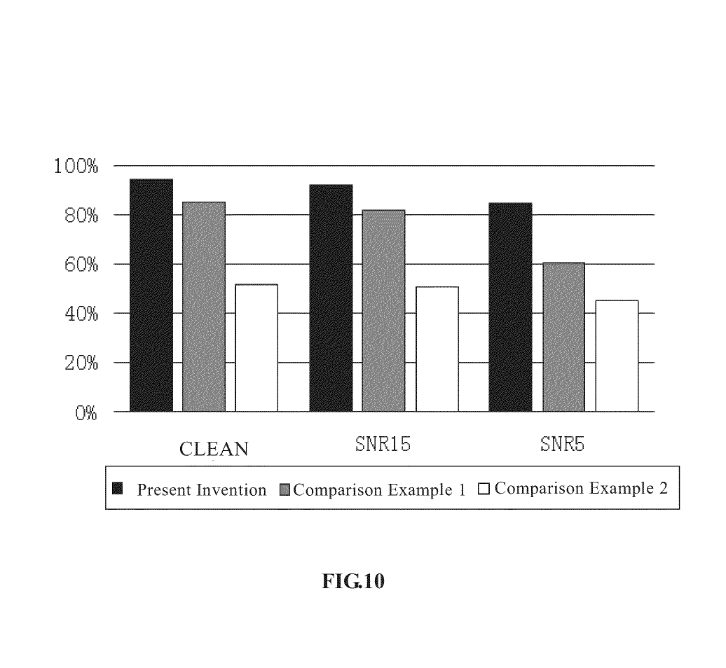

FIG. 10 shows F-measures obtained through testing according to the embodiment of the present subject matter and the methods of the two modes of the Mac OS speech recognition system.

As shown in FIG. 10, the embodiment of the present subject matter gets F-measures of 94% under clean condition, 91% under SNR 15 noisy condition and 85% under SNR 5 noisy condition. The two modes of the Mac OS speech recognition system in the prior art get F-measures of 61% and 46% under SNR 5 noisy condition respectively. It can be observed clearly that the F-measures of the embodiment of the present subject matter are higher than those of the two modes of the Mac OS speech recognition system in the prior art. Accordingly a higher robustness can be obtained by the present subject matter under low SNR noisy conditions as compared to the prior art.

It is possible to carry out the method and system of the present subject matter in many ways. For example, it is possible to carry out the method and system of the present subject matter through software, hardware, firmware or any combination thereof. The above described order of the steps for the method is only intended to be illustrative, and the steps of the method of the present subject matter are not limited to the above specifically described order unless otherwise specifically stated. Besides, in some embodiments, the present subject matter may also be embodied as programs recorded in recording medium, including machine-readable instructions for implementing the method according to the present subject matter. Thus, the present subject matter also covers the recording medium which stores the program for implementing the method according to the present subject matter.

Although some specific embodiments of the present subject matter have been demonstrated in detail with examples, it should be understood by a person skilled in the art that the above examples are only intended to be illustrative but not to limit the scope of the present subject matter. It should be understood by a person skilled in the art that the above embodiments can be modified without departing from the scope and spirit of the present subject matter. The scope of the present subject matter is defined by the attached claims.

What is claimed is:

1. A method for speech command detection comprising:
feature extraction, for extracting speech features from a speech signal inputted into a system;
speech recognition, for converting the speech features into a word sequence, wherein the word sequence comprises at least two successive non-command words and at least one command word candidates, and obtaining time durations of speech segments corresponding to the respective non-command words and an acoustic score of each of the command word candidates;
rhythm analysis, for calculating rhythm features of the speech signal based on the time durations; and
classification, for recognizing a speech corresponding to the at least one command word candidates as a speech command directed to the system or a speech not directed to the system based on the acoustic score and the rhythm features,
wherein the rhythm features describe a similarity of time durations of speech segments corresponding to the respective non-command words, and/or a similarity of energy variations of the speech segments corresponding to the respective non-command words.

2. The method for speech command detection according to claim 1, wherein the speech corresponding to the at least one command word candidates is located before speech segments corresponding to the at least two successive non-command words or after speech segments corresponding to the at least two successive non-command words.

3. The method for speech command detection according to claim 1, wherein the speech segments corresponding to the at least two successive non-command words are provided both before and after the speech corresponding to the at least one command word candidates respectively.

4. The method for speech command detection according to claim 1, wherein the speech segments corresponding to the at least two successive non-command words may be any voices except those corresponding to the at least one command word candidates.

5. The method for speech command detection according to claim 1, wherein the rhythm features comprise at least one of:
an average length of time durations of speech segments corresponding to the at least two successive non-command words;
a variance of time durations of speech segments corresponding to the at least two successive non-command words;
a normalized maximum value of the autocorrelation of energy variations of speech segments corresponding to the at least two successive non-command words;
a base frequency of speech segments corresponding to the at least two successive non-command words; and
energies of speech segments corresponding to the at least two successive non-command words.

6. A device for speech command detection comprising:
a feature extraction unit, for extracting speech features from a speech signal inputted into an information processing system;
a speech recognition unit, for converting the speech features into a word sequence, wherein the word sequence comprises at least two successive non-command words and at least one command word candidates, and obtaining time durations of speech segments corresponding to the respective non-command words and an acoustic score of each of the command word candidates;
a rhythm analysis unit, for calculating rhythm features of the speech signal based on the time durations; and
a classification unit, for recognizing a speech corresponding to the at least one command word candidates as a speech command directed to the information processing system or a speech not directed to the information processing system based on the acoustic score and the rhythm features,
wherein the rhythm features describe a similarity of time durations of speech segments corresponding to the respective non-command words, and/or a similarity of energy variations of the speech segments corresponding to the respective non-command words.

7. The device for speech command detection according to claim 6, wherein the speech corresponding to the at least one command word candidates is located before speech segments corresponding to the at least two successive non-command words, or after speech segments corresponding to the at least two successive non-command words.

8. The device for speech command detection according to claim 6, wherein the speech segments corresponding to the at least two successive non-command words are provided both before and after the speech corresponding to the at least one command word candidates respectively.

9. The device for speech command detection according to claim 6, wherein the speech segments corresponding to the at least two successive non-command words may be any voices except those corresponding to the at least one command word candidates.

10. The device for speech command detection according to claim 6, wherein the rhythm features comprise at least one of:
an average length of time durations of speech segments corresponding to the at least two successive non-command words;
a variance of time durations of speech segments corresponding to the at least two successive non-command words;
a normalized maximum value of the autocorrelation of energy variations of speech segments corresponding to the at least two successive non-command words;
a base frequency of speech segments corresponding to the at least two successive non-command words; and
energies of speech segments corresponding to the at least two successive non-command words.

11. The device for speech command detection according to claim 1, wherein the device is selected from a group comprising: a digital camera, a digital video recorder, a mobile phone, a computer, a television, a security control system, an e-book, and a game player.
